(19) United States
(12) Patent Application Publication
(10) Pub. No.: US 2009/0104860 A1
(43) Pub. Date: Apr. 23, 2009

(54) PORTABLE POWER TOOL

(76) Inventors: Peter Stierle, Pliezhausen (DE); Alfred Frech, Leinfelden-Echterdingen (DE); Steffen Tiede, Herrenberg (DE); Juergen Hesse, Waldenbuch (DE)

Correspondence Address: MICHAEL J. STRIKER, 103 EAST NECK ROAD, HUNTINGTON, NY, 11743, US

(21) Appl. No.: 11/577,784

(22) PCT Filed: Jun. 30, 2006
(86) PCT No.: PCT/EP06/63725

§ 371 Date: Apr. 23, 2007

(30) Foreign Application Priority Data
Aug. 2, 2005 (DE) 10 2005 036 195.1

(51) Int. Cl. B24B 23/00; B24B 27/08; B23Q 5/06

(52) U.S. Cl. 451/344

(57) ABSTRACT

A portable power tool having a housing (12) and a tool (70), in particular a cutting tool, which is arranged thereon in such a way that it can be driven in a rotary and/or oscillating manner and which can be operated as prescribed by means of a suction-air flow, in particular with a dust extractor, is made especially robust and insensitive to clogging by chips by virtue of the fact that a turbine (36) having a rotatable turbine wheel (38) and a fixed turbine casing (60) serves as drive, wherein means (101) for the frictionless discharge/ejection of dust and chips that have entered the power tool inadvertently are arranged between the turbine wheel (38) and the turbine casing (60).

### RELATED ART

The present invention is directed to a hand-held power tool driven by a flow medium, according to the preamble of claim 1.

U.S. Pat. No. 6,347,985 B1 makes known a hand-held power tool that is driven solely via the suction air flow of a vacuum cleaner. The core of the known hand-held power tool is a conventional Pelton turbine that uses the suction air from the vacuum cleaner to rotate the driven spindle and, therefore, to drive the tool. The efficiency and robustness of the known hand-held power tools with axial and Pelton turbines—also referred to as drag-type rotors—that provide mechanical power to a shaft solely via air impulses are not capable of meeting the high demands placed on the output and suction power of these hand-held power tools that can be operated using commercial vacuum cleaners. In particular, particles drawn in with the suction airstream can enter the narrow air gap between the turbine wheel and the turbine housing that exists due to the design. Coarse particles are unable to escape. If they accumulate, they can jam the turbine and impair its performance.

### ADVANTAGES OF THE INVENTION

The advantage of the present invention with the features listed in claim 1 is that a material-removing, hand-held power tool—designed as a sander or a milling machine, in particular—that does not include an electric motor is that it is driven by a turbine which can only be operated with suction air, e.g., from a vacuum cleaner, and that includes a rotatable turbine wheel and a stationary turbine housing. Means are located between the turbine wheel and the turbine housing to carry away and/or eject particles such as dust—and coarser chips, in particular—that accidentally enter this space, without these means reducing the high efficiency of the turbine. As a result, during interference-free operation, a particularly high portion of flow energy of the intake and blast air is capable of being converted to mechanical output. The hand-held power tool can also be used directly as a suction head when it is held over the workpiece and/or the surface to be cleaned, while the turbine is running, and with or without the tool being engaged in the workpiece.

It is also ensured that sanding, milling, drilling, etc., operations that produce nearly no dust in the surroundings can be carried out, while dust particles forming during the sanding process are removed continually, thereby combining a high rate of material removal with highly effective suctioning away of grinding dust. In short, a particularly advantageous type of turbine is created that is basically a cross between a classical direct-flow radial turbine and an axial turbine, and that is designed as a diagonal-flow radial turbine. It combines the advantage of minimal power loss with the advantage of increased energy yield from the airstream and therefore serves as a highly effective drive for air-moving power tools. The risk associated with the outgoing air that drives the turbine by flowing through it and contains particles is offset by certain means. These means are located between the turbine wheel and the turbine housing and serve to carry away or allow the exit of wayward dust and chip particles that leave the main airstream and enter the spaces between the moving parts of the turbine, thereby threatening to impair their motion.

Given that the means are designed, at the least, as an annular opening in the turbine housing close to the inflow point of the drive air, and in front of the lower edge of the turbine wheel, the particles can leave the turbine via a short path, without causing any noticeable blocking or braking effects.

Given that the means described above are also formed via surface recesses and/or an increased surface roughness of the turbine wheel—adjacent to the opening of the turbine housing in particular—that serve to carry and accelerate the particles in order to eject the particles out of this opening—continual particle removal is attained, and the risk of the turbine wheel becoming jammed with the turbine housing is reduced further. Given that the rotational speed of the hand-held power tool is regulated using an adjustable air flap, it is possible to adapt the machine speed to the particular working conditions in an easy, cost-effective manner using simple means.

### DRAWING

The present invention is explained below in greater detail with reference to an exemplary embodiment and the drawing.

FIG. 1a shows a longitudinal cross section of a finishing sander,

FIG. 1b shows a further longitudinal cross section of the finishing sander

FIG. 1c shows a spacial partial-longitudinal cross section of the finishing sander

FIG. 2 shows a longitudinal cross section of the turbine for driving the finishing sander

FIG. 3 is a spacial top view of the turbine in FIG. 2

FIG. 4 is a side view of the turbine in FIG. 2

### DETAILED DESCRIPTION OF THE EXEMPLARY EMBODIMENT

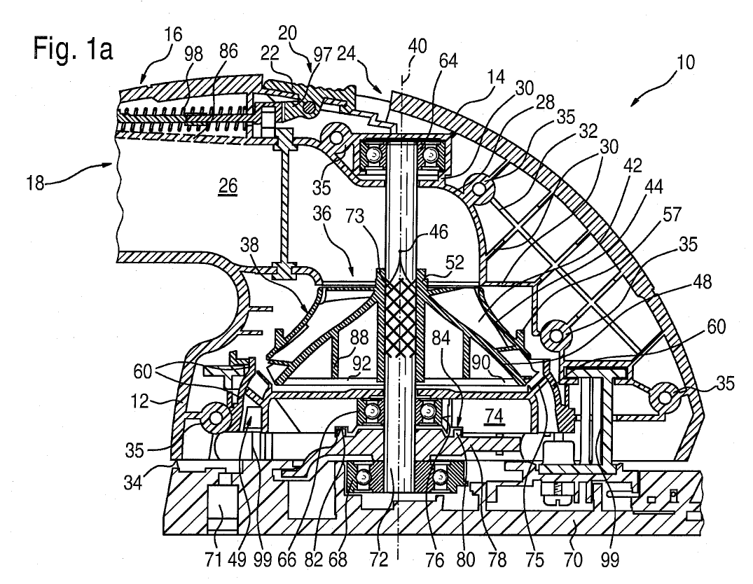

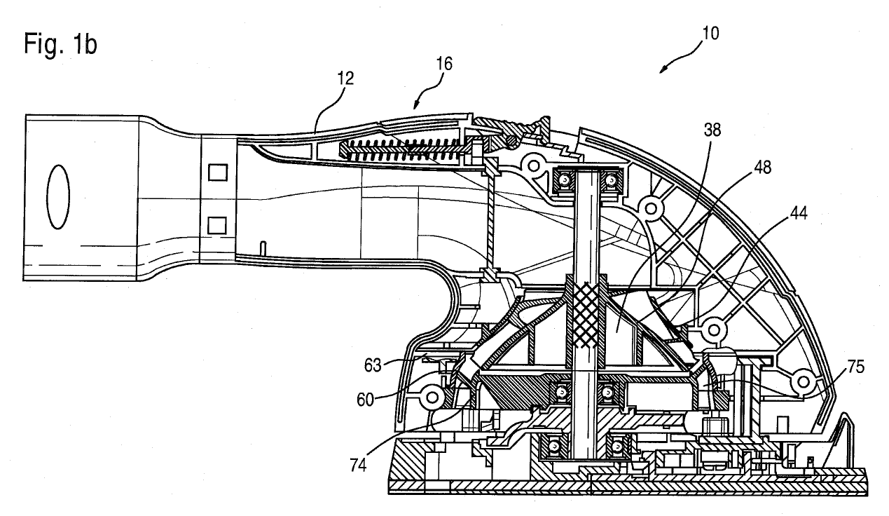

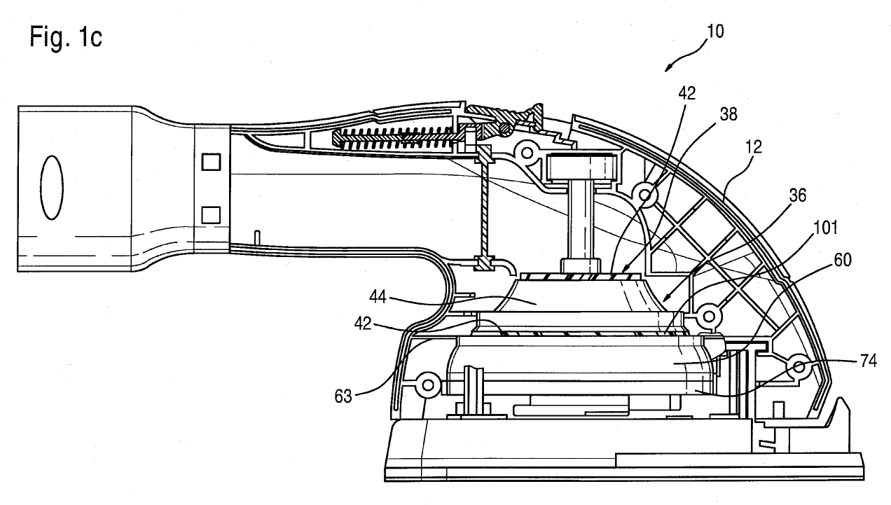

FIG. 1 shows a hand-held power tool 10 designed as a finishing sander, in a view of the interior of housing longitudinal shell 14. It forms—together with a second, not-shown, substantially symmetrical housing shell—a bell-shaped housing 12 with a normal axis 13. Housing 12 is joined by connecting the two housing shells with screws that pass through the outer, not-shown housing shell from the outside, can be screwed into screw mandrels 35, thereby holding the two housing shells together at a vertical joint. On its top side 20, housing 12 transitions into a hollow cylindrical handle 16 that projects transversely from normal axis 13 and serves as suction air outlet 18 and/or a connection for a vacuum cleaner. An air flap 22 is mounted on top side 20 of housing 12, which opens or closes an opening 24 to flow channel 26 inside housing 12, to regulate the air intake as necessary. To this end, a region 86 of a channel wall 28 located close to opening 24 is perforated, so that the suction air can communicate with the outside air in tubular flow channel 26. Channel wall 28 is held on housing shells 14 via support ribs 30. Support ribs 30 are connected with reinforcement ribs 32 inside housing shell 14 and, via these, with the outer wall of the housing and housing shell 14. As a result, air channel 26 and channel wall 28 are reinforced, and, in particular, they are stabilized against vibrations and resonances with the suction air that flows through. At the bottom, housing 12 terminates in a straight, circumferential lower edge 34, whose perpendicular projection downward forms a triangle with outwardly arched sides. A sanding disk 70 is located parallel with lower edge 34 and is connected with housing 12 in an elastically movable manner via elastic, oscillating body 75. Sanding disk 70 extends with its U-shaped base surface outwardly past the triangular, perpendicularly downwardly projected contour of lower edge 34 and has retaining means on its underside for accommodating a not-shown sanding pad. It can be driven in an orbital manner via a drive shaft 72 and an eccentric that is non-rotatably mounted on its end and is not described further, so that each point of the sanding disk and, therefore, every individual sanding grain of the sanding disk forms small circles, i.e., the typical sanding pattern created by an orbital sander.

Drive shaft 72 is driven in a rotating manner via a turbine wheel 38 of an air-drivable turbine 36, and is rotatably supported in housing 12 and in guide-blade row 74 via an upper and lower roller bearing 64, 66 and engages with its lower end in a third roller bearing 68 which is non-rotatably mounted via its outer ring in sanding disk 70. Between lower and third roller bearing 66, 68, drive shaft 72 is non-rotatably connected with a balancing mass 78 which serves to compensate imbalances, in order to cancel out oscillations of eccentrically-moved sanding disk 70 far away from housing 12.

An upwardly projecting annular profile 80—that faces guide-blade row 74—is formed on the top side of balancing mass 78. It is enclosed by an annular groove 82 with slight clearance located in the closely adjacent underside of guide-blade row 74 and, together with annular profile 80, forms a lower, meander-like labyrinth seal 84. This prevents dust and chips from entering the gap or being moved to lower bearing 66 by the vacuum in the cavities in hand-held power tool 10, and between balancing mass 78 and guide-blade row 74 in particular. As such, the gap and lower bearing 66 are protected for a long period of time.

Drive shaft 72 is non-rotatably enclosed in the center by turbine wheel 38, thereby creating an inner, form-fit connection between the two parts via a knurl 73 in a defined circumferential region approximately in the center of drive shaft 72, in the recesses of which liquid plastic enters during the casting process, thereby creating the connection.

Turbine wheel 38 has a bell-shaped outer contour. A guide-blade row 74 with lattice blades 75—guide-blade row 74 being non-rotatably held and being clampable between housing shells 14 in a defined manner using centering cams—abuts lower edge 34 axially downwardly. Lattice blades 75 are designed as plastic strips mounted on their narrow side, similar to wheel blades 42 of turbine wheel 38. Guide-blade row 74, which is designed as a short truncated cone, is at least partially enclosed on the outside by turbine housing 60—which is also non-rotatably supported in housing 12, at a distance equal to the height of lattice blades 75, thereby forming a lower continuation of annular flow channel 49 of turbine wheel 38, through which the suction air is drawn and directed. Via lattice blades 75 of guide-blade row 74, the suction air that flows in from the bottom to drive turbine wheel 38 in its direction of flow, and/or the suction air from flow channel 49 and/or wheel blades 42 of turbine wheel 38 is directed and its swirling is eliminated, thereby improving the efficiency of turbine 36 considerably, especially on the input side. Guide-blade row 74 forms—with a central recess 76 on its underside—a bearing seat for a bearing 66 of lower region of drive shaft 72, which fixes drive shaft 72 in position in housing 12 and guides it.

Turbine housing 60 extends radially via its circular upper edge 61—at an axial distance of approximately 4 mm—past the lower region of turbine wheel 38, where it forms an annular gap 101 with a clearance of approximately 5 mm from wheel cover 44 of turbine wheel 38. Chips and dust particles that have reached guide-blade row 74 are ejected rapidly with the suction air through annular gap 101 without reaching or entering turbine wheel 38 and braking it or blocking it. The particles are slung out of annular gap 101 by the fact that they follow their trajectory—due to inertia—in a frictionless manner and are not redirected with the suction air into wheel blades 42 of turbine wheel 38. The particles are not blown outwardly, they are thrown, because the pressure differential between the interior of the housing—outside of turbine 36 toward the space inside turbine 36—is minimal. These pressure conditions are attributed to the effect of a sealing rib 63, which seals turbine housing 60 to the outside and thereby ensures that, when a vacuum cleaner is connected in the interior of housing 12, a homogeneous vacuum exists everywhere above sealing rib 63, even in turbine 36. Turbine 36 can therefore be operated with minimal pressure loss and high efficiency.

A radially inwardly oriented sealing rib 63 in/on housing 12 that extends transversely to normal axis 40 bears in a sealing manner against turbine housing 60 close to its upper edge 61. As a result, infiltrated air that flows past guide-blade row 74 and/or turbine housing 60 on the outside cannot enter turbine 36 via annular gap 101 and reduce output, and pressure losses in turbine 36 are prevented, because a somewhat homogeneous vacuum exists above sealing rib 63 due to its location, thereby preventing losses from occurring.

The chips that exit openings 101 outwardly can flow out of housing 12 via not-shown, upwardly guiding channels. Inspection flaps or openings can be provided in housing 12 in the region of opening 101, through which particularly tenacious accumulations of chips can be poured out.

FIG. 1 b is essentially identical to FIG. 1 a and clearly shows—without including all of the reference numerals—the details of turbing housing 60 with sealing rib 63, and the position of guide-blade row 74 with its lattice blades 75, and turbine wheel 38 with wheel cover 44 and support cone 48.

FIG. 1 c is a view of the design of housing 12 and turbine 36 located therein, with turbine housing 60, guide-blade row 74, sealing rib 63, and wheel blades 42, which extend beyond wheel cover 44, and annular gap 101.

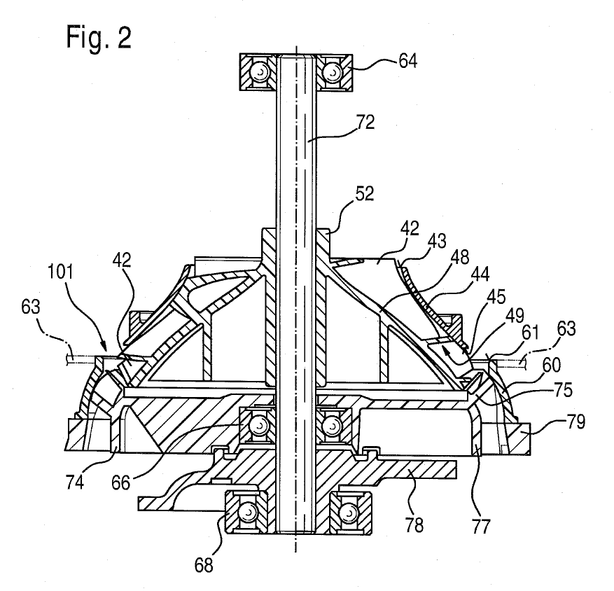

FIG. 2 shows a longitudinal cross section of turbine wheel 38 with guide-blade row 74—which terminates axially downwardly and is fixed in position in housing 12—as an isolated component, while it is shown installed in FIG. 1. A support cone 48 which is shaped like a truncated cone and is arched outwardly—similar to the cone of a juice squeezer—is shown, on which a large number of wheel blades 42 is mounted, which are shaped like flat plastic strips mounted in an upright position via their narrow sides on support cone 48, and the height of which increases gradually in the direction toward the—virtual—cone peak. A wheel cover 44 that extends nearly in parallel with support cone 48 and the upper edges of wheel blades 42 is joined via wheel blades 42. As a result, a flow channel 48 with an annular cross section is formed between support cone 48 and wheel cover 44. It is subdivided by wheel blades 42 into a large number of winding, individual channels, into which the suction air can flow with particularly low flow resistance to drive turbine 36. The lower edge of support cone 48 is tilted at an angle of approximately 45° to the cone axis and extends at an angle of approximately 90° transversely to the cone axis, unlike conventional radial turbines. With a particularly favorable exemplary embodiment of turbine 36, the inflow angle of the blades is 40°, and their outflow angle is 30°. As indicated by directional arrow 62, the air which flows along wheel blade 42 is redirected by 45° relative to axis 40. The redirection transverse to the plane of the drawing is not yet taken into account. Annular gap 101 is visible between cover lower edge 45 of wheel cover 44 and upper edge 61 of turbine housing 60.

It is also shown how the upper edges of wheel blades 42 extend past cover upper edge 43 so that any dust particles or chips that have entered the turbine wheel have more leeway to exit turbine 36 in a frictionless manner and are unable to become stuck on wheel cover 44.

Support cone 48 or truncated cone of turbine wheel 38 is penetrated by a central hollow cylinder 54 that accommodates shaft 72. At the top, in the region of a virtual cone peak, hollow cylinder 54 forms a projecting, annular collar 52. Hollow cylinder 54 therefore attains a length such that drive shaft 72—with a defined axial extension and a defined region of its knurl 73—is positioned securely relative to the turbine wheel via this knurl 73 in the interior of hollow cylinder 54 and is enclosed by it, thereby resulting in reliable rotation between turbine wheel 38 and drive shaft 72.

To operate hand-held power tool 10, air is suctioned at suction air outlet 18 and flows from the outside through suction holes 71 in sanding disk 70 and between the top side of sanding disk 70 and lower housing edge 34. The air drawn in from the outside enters annular channel 49 of guide-blade row 74 and travels further into the annular channel of turbine wheel 38.

If radial turbine wheel 38 and guide-blade row 74 come in contact with abrasive, dusty air, they can become worn and dust can deposit there, which can negatively affect the power and service life of the drive. To prevent this, the surfaces which come in contact with suction air are designed with slight, regular, golf ball-type recesses in particular, so they have low flow resistance and increased surface strength.

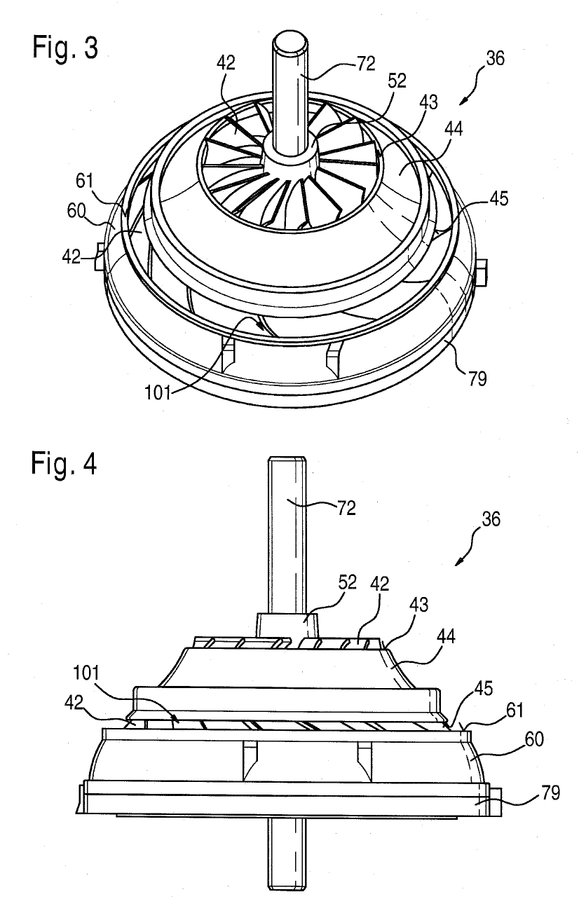

The top view of turbine 36 from FIG. 2 that is shown in FIG. 3 shows turbine housing 60 with annular gap 101, and clearly shows wheel blades 42, which extend above and below wheel cover 44.

Upper edge 43 of turbine housing 60 is offset so far downward, and lower edge 45 of wheel cover 44 is offset so far upward that an open annular gap 101 with an internal diameter of 5 mm is formed between upper edge 43 of bell-shaped turbine housing 60—that encloses guide-blade row 74—and lower edge 45 of wheel cover 44 of turbine wheel 38. Wheel blades 42 are therefore not covered in the lower region, along an edge that is approximately 5 mm wide. As a result, dust particles flowing with intake air through guide-blade row 74 through annular gap 101 continue on a straight trajectory and exit turbine 36 without interfering with operation, i.e., without becoming jammed between stationary and moving parts.

Likewise, cover upper edge 43 is offset so far downward that wheel blades 42 extend axially—via their blade upper edge 41—above cover upper edge 43 by at least 2 mm. As a result, dust particles that have passed turbine wheel 38 can exit via air channel 26 without jamming turbine wheel 38.

Unlike a classical radial turbine, the air which flows through hand-held power tool 10 does not flow purely radially inwardly before it is redirected axially in turbine 36. Instead, it flows in the guide-blade row and in the radial turbine at an angle of 45° relative to normal axis 40 (see FIG. 2). The advantage of this oblique flow is that the efficiency of the turbine is increased markedly, since the loss of pressure inside turbine 36 and guide-blade row 74 is minimized. The inflow angle of the blades is 60°, and the outflow angle is 30°, in order to also keep the outflow losses as low as possible. The angles for the inflow region can vary between 0° and 70°, and the angles in the outflow region can vary between 10° and 60°. The angle is selected depending on the quantity of air and the rotational speed expected. The purpose of guide-blade row 74 is to provide the airstream with the greatest amount of pre-rotation possible. For this reason, it includes lattice blades 75 with an emergent angle of approximately 80°. A slight clearance is required between guide-blade row 74 and turbine 36, so that the airstream can contact turbine 36 in the most ideal manner possible. An additional support ring 88 between support ribs 90 on the underside of support cone 48 prevents a highly fluctuating and uncontrolled no-load speed of the turbine, which can be extreme (>20 000 rpm), since a fan effect cannot occur when ribs are positioned purely radially. Support ring 88 and support ribs 90 are sized such that they become thinner in the radially outward direction, so that, during injection molding, the material can flow outwardly quickly and with low resistance and fill all cavities in the mold.

A side view of turbine 36 shown in FIG. 4 clearly presents the details explained with reference to FIG. 3, but viewed from the side.

What is claimed is:

1. A hand-held power tool with a housing (12) and a tool (70)—a cutting tool, in particular—located thereon in a rotatable manner, it being possible to operate the tool (70) using a suction air flow, via a vacuum cleaner, in particular,
wherein
a turbine (36) with a rotatable turbine wheel (38) and a stationary turbine housing (60) serves as the drive, and means (100) are located between the turbine wheel (38) and the turbine housing (60) for ejecting—in a frictionless manner, in particular—particles (108), such as dust and chips, that accidentally enter this space.

2. The hand-held power tool as recited in claim 1,
wherein
the means (100) are designed as an open annular gap (101) between the turbine housing (60) and the turbine wheel (38).

3. The hand-held power tool as recited in claim 1,
wherein
the means (100) are designed as a shortened cover upper edge (43) of the turbine wheel (38) with impeller blade upper edges (41) of the wheel blades (42) extending over them.

4. The hand-held power tool as recited in claim 1,
wherein
the turbine (36) is provided with means for eliminating the swirling of the inflowing and outflowing air, in particular a guide-blade row (74)—and/or a rear guide grid; the airstream flowing onto the turbine wheel (38) is forwarded or redirected at an acute angle to the normal axis (40) of the turbine wheel (38), at an angle of 50° in particular.

5. The hand-held power tool as recited in claim 1,
wherein
it includes a balancing mass (78) that, together with structures (80, 82) of the guide-blade row (74), forms a labyrinth seal (84).

6. The hand-held power tool as recited in claim 1,
wherein
it is designed as a surface grinding machine, a finishing sander in particular, that simultaneously serves as a dust suction head.

7. The hand-held power tool as recited in claim 1,
wherein
the housing (12) includes a sealing rib (63) oriented radially inwardly and extending transversely to the normal axis (40) that bears—in a sealing manner—against the turbine housing (60) near its upper edge (61).

8. The hand-held power tool as recited in claim 1,
wherein
upwardly guiding channels are located above the sealing rib (63), abutting the opening (101), between the turbine housing (60) and the housing (12) for removal of the chips that exit through the openings (102).

9. The hand-held power tool as recited in claim 1,
wherein
inspection flaps (150) for openings are located on the housing (12), above the opening (101), through which accumulated chips can be poured out.
